(19) United States
(12) Patent Application Publication
(10) Pub. No.: US 2010/0148971 A1
(43) Pub. Date: Jun. 17, 2010

(54) Electrically Actuatable Sanitary Fitting

(75) Inventors: Andreas Wawrla, Widnau (CH); Kurt Wallerstorfer, Strasswalchen (AT)

Correspondence Address: FACTOR & LAKE, LTD, 1327 W. WASHINGTON BLVD., SUITE 5G/H, CHICAGO, IL, 60607, US

(73) Assignee: AQUIS SANITAR AG, Rebstein (CH)

(21) Appl. No.: 12/529,776

(22) PCT Filed: Mar. 6, 2008
(86) PCT No.: PCT/EP08/01795

§ 371 Date: Dec. 9, 2009

(30) Foreign Application Priority Data
Mar. 6, 2007 (DE) 10 2007 011 183.7

(51) Int. Cl. G08B 23/00

(52) U.S. Cl. 340/573.1

(57) ABSTRACT

The flow of water through a sanitary fitting is controlled by a hydraulic control unit through which a cold water stream and hot water stream flow, said control unit emitting a mixed water stream. The hydraulic control unit is controlled in turn by a control unit cooperating with a presence sensor. Said presence sensor monitors an area located in front of the sanitary fitting. If an output signal is emitted by the presence sensor, a display unit is actuated, informing a user that the fitting has recognized said user. At the same time, the control unit is taken out of a sleep mode and set to a working mode.

The invention relates to a sanitary fitting, in particular a washstand fitting, shower fitting, bath fitting, kitchen fitting or flushing fitting.

Sanitary fittings are employed both in the public domain and in the private domain. For various reasons it may be of interest to establish whether someone is about to use the fitting or whether, conversely, a use of the fitting is not needed at present.

By virtue of the present invention, therefore, a sanitary fitting is to be created, in respect of which it is established whether a use in the immediate future is desired or expected or not.

In accordance with the invention, this object is achieved by a sanitary fitting with the features specified in Claim 1.

By virtue of the display unit which is assigned to the sanitary fitting and controlled by a presence sensor, an approaching user is, on the one hand, shown that the sanitary fitting has detected him/her. By virtue of the display, precisely where the sanitary fitting is located is simultaneously conveyed to the user. By a special lighting effect or by tones it can also be signalled to a user that he/she is welcome.

The message conveyed to the user by the display unit may generally be of welcoming and/or informative and/or prompting and/or orienting nature. Accordingly, the user can be informed by the display unit which functions are available, how and where the functions can be triggered, which dangers are impending. The detection of a user can also be used to prepare the fitting for a function.

In this way, a simplification, a facilitation and an enhancement of safety in connection with the use of the fittings are obtained.

Advantageous further developments of the invention are is the subject-matter of dependent claims.

Claim 2 specifies various possible ways in which it can be communicated to a user that his/her presence has been established by the sanitary fitting, amongst them an odour.

The further development of the invention according to Claim 3 has the advantage that the attention of a user is drawn to the sanitary fitting. He/she can consequently readily find said fitting also in spaces that are less well illuminated. In addition, an appealing aesthetic effect for the user arises by virtue of the illumination of the sanitary fitting or by virtue of the light emanating from the sanitary fitting.

The further development of the invention according to Claim 4 permits the sanitary fitting to adjust its operations in accordance with person-specific wishes.

The further development of the invention according to Claim 5 permits the presence of particular persons to be detected from a distance in simple manner and independently of their physical features.

The further development of the invention according to Claim 6 has the advantage that the sanitary fitting is of particularly compact construction and its components can be fully wired at the factory. In this way, the presence sensor is also protected against manipulations.

The further development of the invention according to Claim 7 has the advantage that the detection of the user and the display of the operational readiness of the sanitary fitting are effected already when the user is still at a relatively great distance from the sanitary fitting. The sanitary fitting consequently has time to execute certain preparatory routines, and in this way the user can find his/her way to the fitting more easily.

The further development of the invention according to Claim 8 is advantageous with regard to low costs of the presence sensor.

In the case of a sanitary fitting according to Claim 9 there is the advantage that the operating states and the closing state of the fitting are safely conformed to. Accordingly, it does not happen that a tap carries on running or drips when the user has left it. A sanitary fitting of such a type can also be operated without having to touch any part with the hands.

Particular importance is attached to the further development of the invention according to Claim 10, inasmuch as by virtue thereof a distinct saving of energy in the course of operation of the sanitary fitting is is achieved. This is of interest in particular when the sanitary fitting is being operated from a battery.

Electrically actuated sanitary fittings in themselves are known as such, for example in the form of washstand fittings which are controlled by IR sensors. The control sensors, by virtue of the output signal of which the opening of the fitting is brought about, need a relatively large amount of current in the ready state.

According to the further development of the invention according to Claim 10, connected upstream of the actual control unit which controls the hydraulic controller (solenoid valves etc.) is an activation controller, and the latter operates in a manner depending on the output signal of the presence sensor. The control unit is consequently switched on only when a user of the fitting is approaching. Only then are the control elements thereof capable of being actuated, for example a reflection light barrier which controls the current of water. If no person is standing in front of the fitting, this is evident from the absent output signal of the presence sensor, and the control unit is placed into a sleep mode in which only those circuit parts which are needed for further processing of the output signal of the proximity sensor have voltage applied to them.

With the further development of the invention according to Claim 11 it is ensured that the user of the fitting can undertake different settings in respect of said fitting—for example, magnitude of the current of mixed water and temperature of the mixed water, duration of the output of water, admixture of soap etc. These setting options are disabled so long as no user is located in front of the fitting.

The further development of the invention according to Claim 12 permits a different operation of the sanitary fitting to be predetermined automatically for different persons.

With the further development of the invention according to Claim 14 it is ensured that the sanitary fitting can be controlled in contact-free manner, even when the corresponding control element operating in contact-free manner and the proximity sensor operate in accordance with the same principle. In addition, it is ensured that the sanitary fitting is controlled in contact-free manner (for example, with respect to the setting of the current of water) only when the user is standing closely in front of the sanitary fitting.

A control element may operate either continuously; it may also operate in stages. For instance, a control sensor operating in contact-free manner for the quantity of water in two different response zones can set the quantity of water to two different levels.

The further development of the invention according to Claim 15 is advantageous with regard to a safe operation of the control element also in the case of poor space illumination.

In the case of a sanitary fitting according to Claim 16, a user is already informed of the inoperability thereof when he/she is still relatively far away from this sanitary fitting. He/she can then, for example, select an adjacent sanitary fitting in a public washroom.

The further development according to Claim 17 is advantageous for the purpose of avoiding a crosstalk from the display unit to the presence sensor.

With the further development of the invention according to Claim 18 it is ensured that the user can already be welcomed and information can already be given to him/her before he/she has reached the fitting and possibly operated it incorrectly.

With the further development according to Claim 19 it is ensured that, for example, the user finds out (output of data by the display unit) how much water he/she has consumed, what the average temperature of the water was etc., and (where appropriate, in a manner specific to him/her) is bid farewell (lighting effects and acoustic output by the display unit).

Exemplary embodiments of the invention will be elucidated in more detail below on the basis of the drawing. Shown in the latter are:

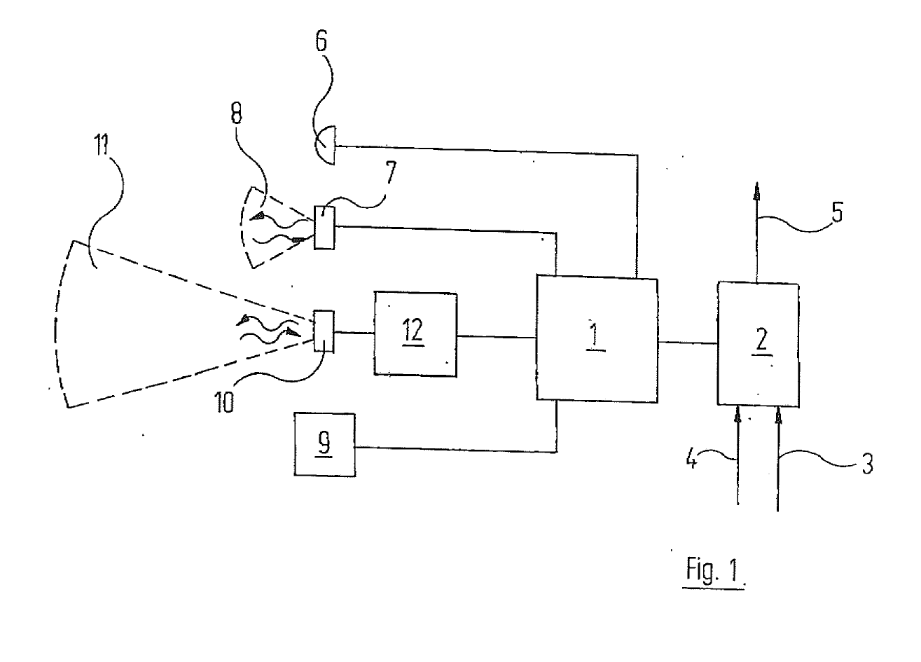

FIG. 1: a block diagram of a mixed-water supply unit for a sanitary mixed-water outlet, which operates in a manner depending on the output signal of a presence sensor;

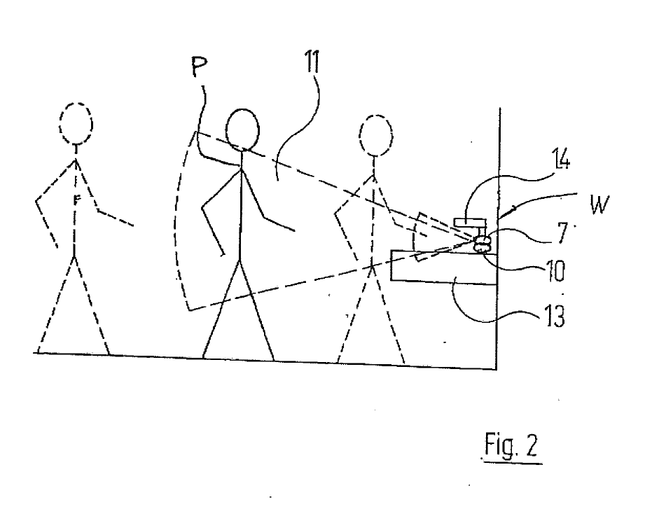

FIG. 2: schematically, the mode of operation of a washstand outlet operated with the supply unit according to FIG. 1;

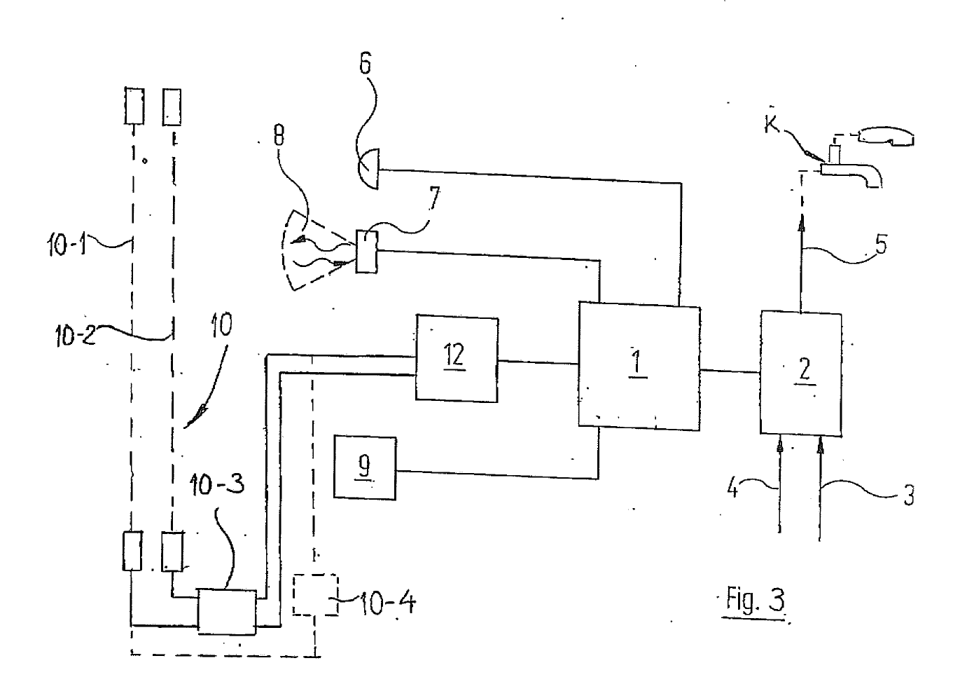

FIG. 3: a block diagram similar to that of FIG. 1, whereby, however, a modified presence sensor is provided which operates in person-specific manner;

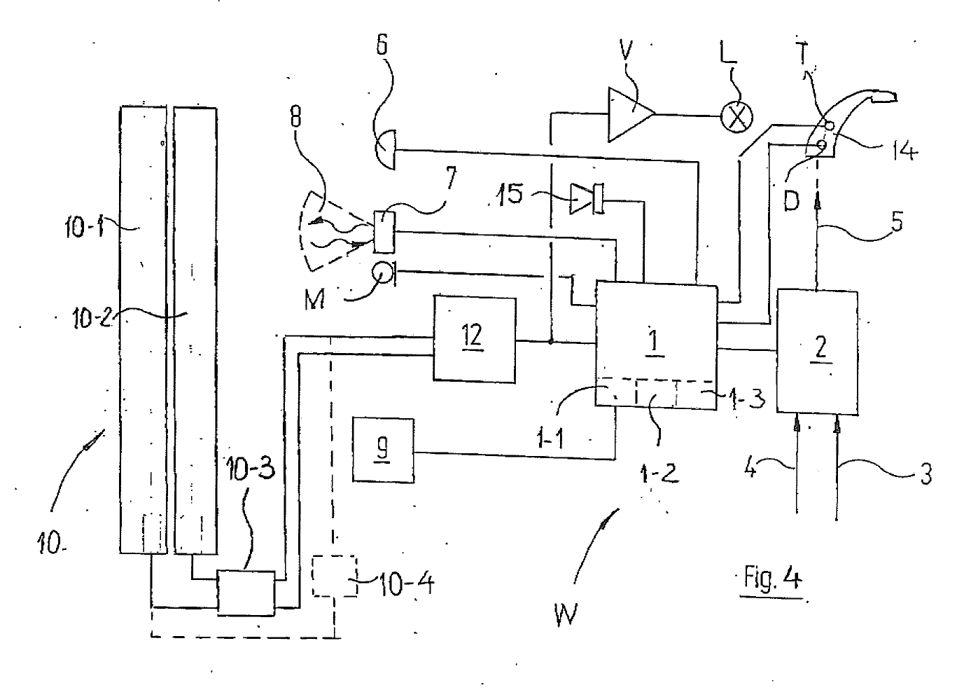

FIG. 4: a view similar to that of FIG. 1, in which a presence sensor operating in person-specific manner, proceeding from the weight of a person, is provided;

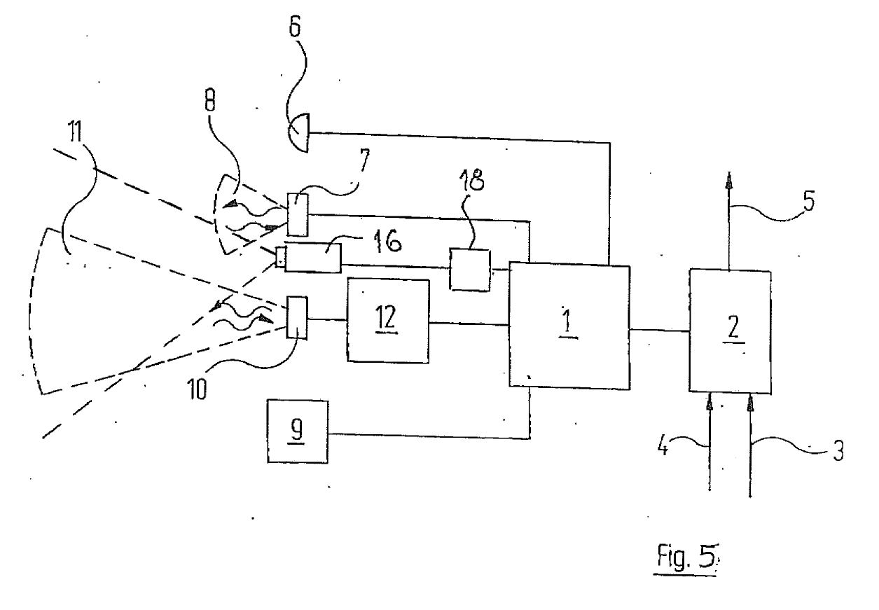

FIG. 5: a view similar to that of FIG. 1, in which, however, use is made of a presence sensor that operates in the manner of an access control; and

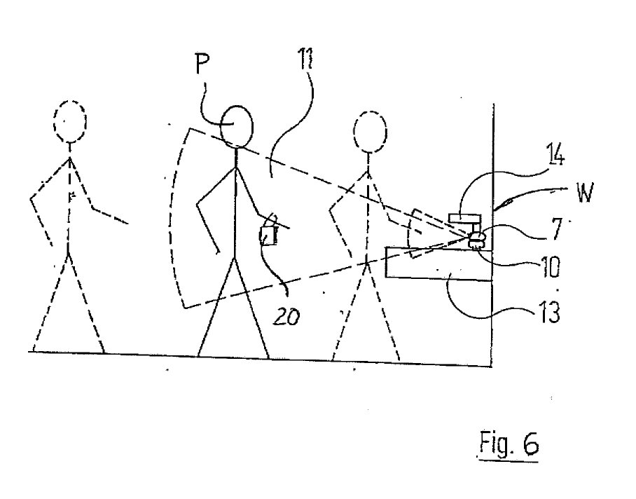

FIG. 6: a view similar to that of FIG. 2, in which, however, use is made of a presence sensor that distinguishes persons on the basis of tags worn by them.

Reference will firstly be made to FIG. 1. The circuit arrangement represented here in the block diagram comprises roughly two parts: a control part, which serves for control of currents of water and which with an outlet —for example, a washstand outlet, a bath outlet or a shower outlet—constitutes a sanitary fitting; and an activation part, which activates or deactivates the control part, depending on whether a person is located in front of the fitting or not.

Firstly those elements will be briefly described which are customary in the case of electrically actuated sanitary fittings and which therefore do not require further detailing.

An electronic control unit 1 forwards commands to a hydraulic controller 2 in accordance with the wishes of a user. The hydraulic control unit 2 contains all those electrically operated elements—in particular solenoid valves, motor-actuated valves, thermostatic valves etc.—which serve for control of the total quantity of water and for control of the temperature of the mixed water. This is effected, for example, by control and mixing of a current of cold water 3 supplied to the hydraulic control unit 2 and of a current of hot water 4 supplied to the hydraulic control unit 2.

At control elements 6, 7 the user can enter his/her wishes with respect to quantity and temperature of the water that is output. Control elements of such a type may be control elements actuated mechanically (control element 6) or control elements actuated in contact-free manner (control element 7). As an example of a control element operating in contact-free manner, a reflection light barrier with a relatively small detection zone 8, limited to short distances, has been sketched in FIG. 1. Instead of the reflection light barrier, use may also be made of proximity sensors that respond to non-metallic objects, for example ultrasonic sensors.

The values entered at the control elements 6, 7—which stand, for example, for the temperature and quantity of the desired current of mixed water 5—can be visualised on a display 9.

The control elements 6, 7 and the display 9 are illuminated, be it by external light-sources or by integrated light-sources.

The part of the circuit arrangement described so far must, if it is provided on its own, be kept constantly is below operating voltage. Hence the circuit arrangement constantly consumes current, in particular also in the often long periods in which an operation of the sanitary fitting is simply not desired. Particularly when the current for operating the sanitary fitting has to be taken from a battery, there are unnecessarily high operating costs.

An electrically actuated sanitary fitting as described hitherto may also be unintentionally actuated wrongly, for example by forgotten objects in the beam path of the reflection light barrier 7, by animals or such like.

With the now additionally described circuit part it is ensured that the control unit 1 and hence also the hydraulic controller 2 cannot operate if no person is located in front of the washstand fitting.

For this purpose a presence sensor 10 operating in contact-free manner is provided, which has a relatively large, wide detection zone 11. Said presence sensor is connected to an activation circuit 12 which may be a discriminator and in practice may have been integrated into the control unit 1.

The control unit 19 is switched between two different operating modes by the output signal of the presence sensor 10.

In a first operating mode, a sleep mode, only those elements of the control unit 1 are supplied with current which serve for detecting the output signal of the activation circuit 12. Those circuit elements which serve for operating the control elements 6, 7, the display 9 and the illumination means thereof and which supply these with current are switched off, so that the current consumption of the control unit 1 is low.

In the second operating mode of the control unit 1, a working mode, all the control elements 6, 7, the display 9 and the illumination means thereof are activated.

The mode of operation that can be achieved with the circuit arrangement described above on the basis of FIG. 1 in the case of a washstand fitting will he elucidated on the basis of FIG. 2. Represented therein is a washstand outlet 14 arranged on a washstand 13, to which the short-range control sensor 7 and the long-range presence sensor 10 are fitted.

The electronic control unit 1 and the hydraulic controller 2 are not represented in FIG. 2. They are accommodated at a suitable place in the building, for example in the wall or in a built-in box under the washstand 13.

If a user P approaches the washstand 13, he/she firstly comes into the relatively large detection zone 11 of the presence sensor 10. This is recognised by the activation circuit 12, which emits a signal to the electronic control unit 1. The latter has hitherto been in the sleep mode, so that the control elements 6, 7 of the display 9 and the illumination means assigned to said display were deactivated. After reception of the output signal of the activation circuit 12, however, all these elements are placed into their functional state.

This means that the control elements 6, 7 are provided with the requisite operating voltages and can therefore now be actuated, and the display 9 is operational. By virtue of the lighting-up of the illumination means assigned to the display 9, the visitor is ‘welcomed’, and the readiness the washstand outlet 14 for a use by the incoming person is signalled. The person can now accept commands with which the user specifies his/her wishes.

If the user now steps closer to the washstand 13, he/she can in the usual manner communicate his/her wishes to the washstand fitting W, which is constituted by the supply part shown in FIG. 1 and the washstand outlet 14.

This can be done either by virtue of the fact that he/she enters—for example, with his/her hand—the smaller detection zone 8 of the contact-free control element and in this way prompts the control unit 1 to, for example, cause the current of water to flow by switching of corresponding solenoid valves of the hydraulic controller 2. By further actuation of control elements—for example, the manually actuated control elements 6 or further control elements operating in contact-free manner—the user can now determine, as desired, the mixing ratio of the current of cold water 3 and the current of hot water 4—that is to say, the temperature of the current of mixed water 5—and, by control of a proportional valve, the quantity of the current of mixed water 5.

All the corresponding values are made visible to the user on the display 9, be it in the form of text, or be it in the form of graphical representations.

If the user leaves the larger detection zone 11 of the presence sensor 10 after use of the washstand fitting W, the electronic control unit 1 reverts—where appropriate, after a predetermined delay time—to its current-saving sleep mode.

With the terminating of the output of water (basic function of the fitting), information about the withdrawal of water is preferentially represented on the display 9, in particular the required quantity of water, the duration of the withdrawal of water, the average temperature of the water, the additional output of washing lotion etc.

With the termination of the output of water, a secondary function of the fitting can be initiated by the control is unit, for example the driving of a towel-dispenser for output of a disposable towel or textile towel, or the driving of a hot-air hand-drier, the output of a hand-care agent, the output of advertising leaflets or of a product sample from a machine etc.

In addition, with the switching-off of the basic function a farewell routine of the control unit 1 is preferentially initiated. This may comprise lighting effects, speech outputs, music etc. This may again be effected in person-specific manner if desired.

Through the choice of the shape of the lobe-like detection zone 11 of the presence sensor 10 a type of child lock can also be achieved. For if the detection zone 11 is directed exclusively into a spatial zone that detects grown-up persons, the approach of smaller persons has no effect on the presence sensor 10 and the control unit 1 remains in its sleep mode.

In the exemplary embodiment according to FIG. 3 a modified presence sensor 10 is shown which consists of two transmission light barriers 10-1 and 10-2, the beams of which run parallel to the wall on which the washstand 13 is fitted.

The output signals of the two transmission light barriers 10-1 and 10-2 are transmitted to a direction-recognition circuit 10-3 which determines, from the temporal sequence of the interruption of the transmission light barriers 10-1 and 10-2, whether a person interrupting the light barriers is moving towards the washstand 13 or moving away from the latter.

Correspondingly, the direction-recognition circuit 10-3 outputs at its one output a signal that indicates the approach of a person, at its output a signal that indicates the departure of a person. By the first-mentioned signal the control unit 1 is switched on; by the second signal it is placed back in its sleep mode again.

The design of the presence sensor 10 shown in FIG. 3 also permits persons to be recognised already who are still located relatively far away from the washstand 13, without a presence sensor 10 that has particularly high sensitivity having to be used.

For practical purposes the two transmission light barriers 10-1 and 10-2 can be incorporated into the doorframe of a door via which the room in which the washstand outlet is located is entered.

Again, by virtue of the height at which the light-barrier arrangement is arranged it can be determined whether the presence sensor 10 responds only to relatively tall persons or to relatively tall and relatively short persons.

In a modification of the exemplary embodiment described above, use could also be made of only a single transmission light barrier, for example transmission light barrier 10-1, and the output signal thereof could be transmitted to a timing element 10-4, the period of which is set to a time that is sufficient for washing the hands, for example 5 minutes or 10 minutes, as sketched in FIG. 3 by dashed lines.

The control unit 1 is then switched on for an appropriate time-interval by the timing element and is then reset automatically into the sleep mode after expiry of the time-interval.

In the exemplary embodiment according to FIG. 3 the hydraulic controller 2 is connected to a combined outlet s K which may be shower/bath outlet or a sink/sprinkler outlet.

If the hydraulic controller 2 is only designed for controlling cold water, the port thereof can also be connected to a urinal.

In the exemplary embodiment according to FIG. 4 the presence sensor 10 includes, instead of two light barriers, two pressure-sensitive mats or boards 10-1 and 10-2 which in each case made available at an output a signal that is assigned to the weight of a person standing on the mat.

Also in this manner the presence sensor 10 is able to distinguish between adult persons and children or between adult persons and children, on the one hand, and animals, on the other hand. Again, from the sequence of the output signals of the mats it can be determined whether a person is walking towards the washstand or going away from the latter.

The corresponding circuit parts correspond to those of FIG. 3.

The signals transmitted to the control unit 10 include not only the direction of movement but also the weight of the person walking over the mats.

A further difference of the circuit arrangement according to FIG. 4 consists in the fact that a light-source L which serves to illuminate the washstand outlet 14 is driven by the output signal of the activation circuit 12 via an amplifier V. The light-source L may either have been sunk into the washstand 13, so that it illuminates the washstand outlet 14 obliquely from below. The light-source L may also include a plurality of lamps (e.g. white-light diodes) which, sunk within the washstand 13, surround the foot of the washstand fitting 14.

The washstand fitting W consequently welcomes a person stepping towards it by means of illumination, which on the one hand is aesthetically appealing and on the other hand draws the attention of the user to the fitting.

The mats 10-1 and 10-2 do not just permit it to be discerned from their output signals that .a person is walking towards the washstand or going away from the latter; the amplitude of the output signal also permits the weight of the person to be discerned. In this manner it is possible to distinguish various users defined previously (e.g. in a learning phase of the control unit) via their weight.

In the control unit 1 various data records 1-1, 1-2, 1-3 etc. can now be provided which predetermine in which manner the respective user is able to communicate with the control elements 6, 7.

In this way it can, for example, be predetermined for children that the temperature of the mixed water cannot be raised above a particular value. Hence the risk is eliminated that a child may be scalded by incorrect operation of the fitting. Also for children the amount of the jet of water that is output can be specifically reduced, and in this way the risk of water getting onto the floor of the room in which the washstand is located can be reduced. Furthermore, the time beyond which a tap may be operated can be limited for particular users.

If the light-source L is one that is controllable in colour, the colour, or a sequence in which the colour of the light-source is changed, can be set, depending on the wish of the different user.

In the exemplary embodiment according to FIG. 4 there is provision furthermore that an acoustic output unit 15 is connected to the control unit 1.

This acoustic output unit can be used to acknowledge inputs at electrical control elements by clicking or beeping. But it can also be used to reproduce music and speech. Which piece of music is reproduced in the individual case can be determined by the control unit 1, again in accordance with the person approaching the washstand in the given case, since corresponding instruction codes pertain to the person-specific data s records 1-1, 1-2, 1-3 etc. which are selected by the output signal of the proximity sensor 10 operating in person-specific manner.

In the case of the sanitary fitting W shown in FIG. 4, a microphone M is furthermore provided which is connected to the control unit 1. This microphone can be used, in conjunction with a speech-recognition module of the control unit 1, to convert spoken commands into actions.

In those applications in which the ambient noise-level is low, the microphone M can also be used as a proximity sensor in order to switch the control unit on. In such a case the proximity sensor 10 (according to FIG. 3 with components 10-1 to 10-3 or 10-1 and 10-4) may then be dispensed with.

According to FIG. 4, two sensors are furthermore incorporated into the water outlet 14, namely a flow sensor D and a temperature sensor T. The outputs of these sensors are connected to the control unit 1. In this way the latter can compare the actual flow and the actual temperature of the mixed water, which is leaving the outlet 14, with the corresponding desired values that have been set by the user. If the control unit 1 establishes that actual values and desired values differ from one another impermissibly greatly, it disables the washstand fitting to prevent further use. In this way, for example, the water outlet 14 can be prevented from always outputting exclusively hot water, even though the output of mixed water with a temperature within the range from 25° C. to 35° C. was requested by the user.

This disabling of use also has the consequence that the control unit 1 suppresses the driving of the display 9 and of the light-source L. A potential user can then infer from the absence of the greeting that the corresponding washstand fitting is not operational and, in a washroom with several washstands, can select another washstand.

In the case of disabling of the sanitary fitting to prevent use, the control unit 1 can also suppress or replace the greeting by the loudspeaker 15 by output of a message by which attention is drawn to the defectiveness of the fitting.

In the exemplary embodiment according to FIG. 5 a person-specific detection of persons approaching the sanitary fitting is effected by virtue of the fact that the outline thereof is ascertained via a television camera 16 which is preferentially integrated within the washstand outlet 14. Alternatively, the camera may also have been installed on the wall of the building supporting the washstand, as is preferred here for the purpose of better representation.

If use is made of a television camera 16 (camera chip) that has only low power consumption, said camera may constitute the presence sensor. The image generated thereby can then be evaluated as to whether a difference arises in comparison with the image recorded in the case of an empty room. For this purpose an appropriate monitoring circuit 18 may have been provided. By virtue of the output signal thereof, the control unit 1 is then again changed over from the sleep mode into the working mode in a manner similar to that described above for other proximity sensors 10.

If in the case of the television camera 16 it is a is question of one that has higher energy demand, a presence sensor 10 such as was described above can also be retained and the television camera 16 can be connected to the control unit 1 as regards its supply, so that it is only activated if the presence sensor 10 which is then retained has responded.

The monitoring circuit 18 is preferentially also used to compare the respective camera image with a number of master images saved previously (e.g. in a learning phase) and in this way to identify the approaching person.

In accordance with the person approaching in the given case, the data record 1-1, 1-2, 1-3 etc. assigned to him/her is again selected, as a result of which the operating options and functions of the washstand outlet have again been set in person-specific manner.

It was described above that the recognition of the different persons is undertaken by evaluation of their silhouette. Alternatively, a discrimination of persons can also be undertaken via the colour of the clothing worn by them.

In the exemplary embodiment according to FIG. 6 a wireless electromagnetic proximity sensor 10 co-operates with a tag 20 which is worn by the person P.

In the case of the tag 20, it may be a question of an RFID tag, similar to that which is used for theft monitoring of goods in department stores. It may also be a question of a TEMIC transponder tag such as is used in electronic car locks or in safety monitoring systems, which exchanges person-specific electromagnetic bit streams with the sensor.

From the signal of the tag 20 the proximity sensor 10 can consequently infer which person is approaching the washstand fitting W. Correspondingly, the control unit 1 can again operate in person-specific manner.

On the basis of the exemplary embodiments described above it has been explained how a person who is approaching a sanitary object can be detected, and, if desired, can be identified or can be assigned to a group of persons.

This was effected on the basis of an example constituted by a washstand fitting which is used by a person.

It will be understood that a similar procedure can be adopted in the case of other sanitary devices, for example in the case of a bath fitting or a shower fitting. Also for other sanitary devices the welcoming of a person and/or the switching-on of a control unit can be effected in a manner analogous to the exemplary embodiments described above.

Those functions which the control unit preferentially controls in person-specific manner also do not need to relate only to the water-control functions. Accordingly, in the case of a height-adjustable washstand the height can be automatically adapted to a recognised person. The same applies to a WC that is adjustable in height.

Within the trend of the wellness movement, lighting effects and music effects are also increasingly being used in sanitary spaces nowadays, which—by analogy with the exemplary embodiments described above—can be predetermined in person-specific manner.

It will be understood that acoustic signals and other perceptible signals may also be used as display signals of the displays in addition to light signals, in which case the signals may be employed individually or in combination.

1. A sanitary fitting comprising a presence sensor for monitoring a space adjacent to the sanitary fitting, and a display unit is controlled in a manner depending on an output signal of said presence sensor.

2. The sanitary fitting of claim 1, wherein the display unit is a display unit that is capable of being perceived visually, acoustically, by sensory means or by tactile means.

3. The sanitary fitting of claim 1, wherein the display unit includes a light-source which illuminates the sanitary fitting and/or is integrated into the latter.

4. The sanitary fitting of claim 1, wherein the presence sensor distinguishes persons from one another who are located in the space being monitored on the basis of person-bound identification means including any of the following: geometry, weight, or speech, or by properties of clothing including colour, or by identifying tags worn directly or on clothing.

5. The sanitary fitting of claim 4, wherein the tag co-operates electromagnetically with the presence sensor.

6. The sanitary fitting of claim 1, wherein the presence sensor is integrated into the sanitary fitting.

7. The sanitary fitting of claim 1, wherein the space monitored by the presence sensor includes at least one point or one line, the distance of which from the sanitary fitting amounts to at least 1 metre.

8. The sanitary fitting of claim 1, wherein the presence sensor monitors a narrow spatial zone, and a timing element is initiated in response to the monitoring thereof.

9. The sanitary fitting of claim 1, wherein it is actuated electrically.

10. The sanitary fitting of claim 9, further comprising:
a) an electronic control unit;
b) a hydraulic controller which contains at least one electrically actuatable element which influences the quantity and/or the nature, of a current of water emerging from the hydraulics in accordance with an output signal of the control unit;
c) at least one electrically operating control element and/or display which is/are connected to the electronic control unit;
d) the electronic control unit is capable of being operated in two operating modes, namely
da) in a working mode in which all the electrical loads and the at least one control element and/or the display, are operational and are supplied with the respective operating voltage; and
db) a sleep mode in which only some of the electronic components of the control unit are supplied with the respective operating voltage and are operational, wherein the at least one control element and/or the display is/are not supplied with operating voltage; and
e) the electronic control unit is designed in such a way that it is switched the output signal of the presence sensor between the sleep mode and the working mode.

11. The sanitary fitting of claim 10, wherein the control unit controls a plurality of different functions of the fitting.

12. The sanitary fitting of claim 11 wherein the presence sensor distinguishes persons from one another who are located in the space being monitored on the basis of person-bound identification means including any of the following: geometry, weight, or speech, or by properties of clothing including colour, or by identifying tags worn directly or on clothing, and further wherein the control unit exhibits a plurality of person-specific working data records which are activated in accordance with a person-specific output signal of the presence sensor to activate and/or deactivate and/or modify and/or disable person-specific functions and/or displays.

13. The sanitary fitting of claim 10, wherein at least one control element is manually actuatable.

14. The sanitary fitting of claim 10, wherein the control element is a control element operating in contact-free manner, the detection zone of which is smaller than the monitored space of the presence sensor.

15. The sanitary fitting of claim 10, wherein at least one control element exhibits an illumination.

16. The sanitary fitting of claim 1, wherein the control unit activates the display unit only when the fitting is operating faultlessly.

17. The sanitary fitting of claim 1, wherein the presence sensor and the display unit are spatially separated from one another.

18. The sanitary fitting of claim 1, wherein the display unit is activated before a basic function of the fitting is triggered or can be triggered.

19. The sanitary fitting of claim 1, wherein the display unit is activated after a basic function of the fitting has been concluded.
